(19) United States
(12) Patent Application Publication
(10) Pub. No.: US 2008/0183691 A1
(43) Pub. Date: Jul. 31, 2008

(54) METHOD FOR A NETWORKED KNOWLEDGE BASED DOCUMENT RETRIEVAL AND RANKING UTILIZING EXTRACTED DOCUMENT METADATA AND CONTENT

(75) Inventors: Thomas Y. Kwok, Washington Township, NJ (US); Thao N. Nguyen, Katonah, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/668,560

(22) Filed: Jan. 30, 2007

(51) Int. Cl. G06F 7/00

(52) U.S. Cl. 707/5

(57) ABSTRACT

A method, article, and system for managing document retrieval and ranking, and more particularly to providing a method, article, and system for utilizing not just the explicit metadata of a retrieved document, but also the extracted intrinsic metadata inside the content of the retrieved document, as well as the knowledge of the user-document relationship by relating the document implicit metadata to the user's information on the document's system database, as important parameters in calculating relevance or ranking score for retrieved documents.

### BACKGROUND OF THE INVENTION

1. Field of the Invention to Electronic

This invention relates generally to software that manages document retrieval and ranking, and more particularly to providing a method, article, and system for utilizing the explicit metadata of retrieved documents, the extracted intrinsic metadata inside the content of retrieved documents, and knowledge of user-document relationships as important parameters in calculating relevance or ranking score for retrieved documents.

2. Description of the Related Art

There are many different document-ranking methods for query results. A large number of them are optimized in terms of performance, recall and precision ratios for searching relevant documents on the Web. Some advanced ranking methods retrieve and utilize the user searching preferences, selection types and histories. Ranking of retrieved scientific or technical documents usually use keywords in titles, abstracts, contents, and metadata. Ranking of other retrieved documents often include keywords in contents, metadata, okapi formulae, semantic, correlation factors, and others. Some advance ranking methods also monitor and record, for example, those sites from where the user frequently selected their documents in a query list of retrieved documents, and the user's preferred document types. The information used in the ranking methods is most likely linked to client side cookies stored on the user or client side by search engines. Some search engines may only store a user key on the client side as a single cookie and use it to retrieve detailed information stored on their servers. This information is used for calculating the relevant scores of matching documents returned from the query or search on the search engine's database. The retrieved documents are then ranked and sorted according to their relevant scores before sending them to the client and being displayed to the user.

Additional advanced ranking methods also utilize the information on the relevant documents retrieved from query or search. These ranking methods can calculate the relevant scores from the retrieved documents based on their popularity, where are they originated from and who created them, and whether their document types matched the user's preferences and selection histories. In the case of scientific or technical documents, which contain unique title and abstract, authors, key words, subject and outline, methods used to calculate their relevant scores based on the document's contents are also well defined.

However, in the enterprise and business world there are hundreds of electronically generated documents, in particular business related documents, created and stored each day. These electronic business documents can be procurements, purchase orders, invoices, agreements, contracts and any types of business related documents. In the case of business and contract documents, there are some explicit metadata associated with the document, such as creation date, modification and accessed dates, title, subject, author, manager and company, category, keywords, comments and so on, which the user can add in the document properties in a word processor like Microsoft Word. For a Portable Document Format (PDF) document, the user can add title, subject, keywords, created and modified dates, Uniform Resource Locators (URL) and search index as document properties. But there may be no unique titles for each type of business and contract document, as many business or contract documents will have the same title if they are created using the same business or contract template. In addition business documents share the same set of keywords, have few metadata, have varying levels of security control access, and may require parsing and text extraction from documents in various formats (i.e. PDF, tiff, etc.). Thus, calculating document relevant scores or sorting the retrieved business or contract documents based solely on their explicit metadata are not sufficient to guarantee a high precision and reliable recall ratios.

For business related documents (including forms) there is a need to look inside the contents of the retrieved business or contract documents to reveal their relevance with respect to a user's query. As a result, it is required to calculate their relevant scores not just based on their explicit metadata, but more importantly their extracted implicit metadata such as company name and contract numbers, ordered or purchased items, customer name and address, and other parameters. Moreover, the user may not be authorized or allowed to access all the retrieved business or contract documents. Some users may be able to access only those contracts that they created. Furthermore, most users would prefer to see retrieved documents that belong to their departments on the top of the list when compared with retrieved documents that belong to other or alternative departments. In general users would prefer to see active contract documents on the top of the retrieval list relative to expired contract documents. A user may also want to have contract documents with high monetary or unit values ranked higher than contract documents with low values. However, none of the document ranking methods in use today has the ability to utilize the extracted implicit metadata of retrieved documents, and the relationship between the user and the retrieved documents constructed from the explicit metadata and the extracted implicit metadata.

The present invention is directed to addressing, or at least reducing, the effects of, one or more of the problems set forth above, by utilizing not just the explicit metadata of a retrieved document, but also the extracted intrinsic metadata inside the content of retrieved document, as well as the knowledge of the user-document relationship by relating the document explicit metadata and the extracted implicit metadata to the user's and document information on the system's database, as important parameters in calculating relevance or ranking score for retrieved documents.

### SUMMARY OF THE INVENTION

A method for managing document retrieval and ranking from a system, wherein the method includes: determining explicit metadata of the retrieved document; extracting intrinsic metadata from inside the content of the retrieved document; wherein the explicit metadata and the intrinsic metadata comprise document information; establishing a knowledge of the user-document relationship by relating document information to a user's information on a document system or search engine database (server) or retrieved from the user's system (client); calculating a relevance or ranking score for each of the retrieved documents based on the explicit metadata, intrinsic metadata, and knowledge of user-document relationship, as well as the static and dynamic ranking rules constructed from the user's information or inputted directly by the user or an administrator of a group of users; and wherein the method further comprises: entering a query by a user into the system with a client user module; constructing a system query by the system based on said entering; retrieving information about the user by the system; reconstructing the system query with the user information by the system; sending the reconstructed system query from the client user module to an application server by the system; retrieving the document in response to the reconstructed system query by the application server; constructing static or dynamic ranking miles from the user's information or input from user or administrator, and ranking the retrieved document by the application server.

An article including one or more machine-readable storage media containing instructions that when executed enable a processor to access a document retrieval and ranking program in a system that comprises computer servers, mainframe computers, desktop computers, and mobile computing devices; and wherein the document retrieval and ranking program facilitates document searches; and wherein the document retrieval and ranking program provides for managing document retrieval and ranking from the system by utilizing not just explicit metadata of a retrieved document, but also extracted intrinsic metadata inside content of the retrieved document, and static and dynamic ranking rules constructed from the user's information or inputs from the user or administrator (responsible for a group of users), knowledge on user and retrieved documents dynamically built from the retrieved user and document information from the user's system (client side), the systems and database of the retrieved document and search engine (server side), and the dynamically constructed user-document relationships based on the relationship rules and the dynamic knowledge of the user and retrieved document, as important parameters in calculating relevance or ranking score for the retrieved documents.

A system for managing document retrieval and ranking by utilizing not just explicit metadata of a retrieved document, but also extracted intrinsic metadata inside content of the retrieved document, and knowledge and ranking rules dynamically built on a user and the retrieved document based on the extracted data, and forms a dynamically constructed user-document relationship based on the static relationship rules retrieved from the system or dynamic relationship rules inputted by the administrator, and the knowledge on the user and the retrieved document by relating document implicit metadata to a user's information on the systems or databases of the user, retrieved documents and search engines, as important parameters in calculating relevance or ranking score for the retrieved documents, wherein the system includes computing devices and at least one network; and wherein the computing devices implement the document database; and wherein the computing devices further include: computer servers; mainframe computers; desktop computers; and mobile computing devices; and wherein the computing devices execute electronic software that manages the document retrieval and ranking; and wherein the electronic software is resident on a storage medium; and wherein the computing devices have the ability to be coupled to the network; and wherein the network further includes: local area network (LAN); wide area network (WAN); a global network; Internet; intranet; wireless networks; and cellular networks

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1C are block diagrams depicting a document ranking system for query results employing user-document relationship parameters with dynamically extracted user and document information for a Web based application according to an embodiment of the present invention.

FIG. 2 is a flow diagram illustrating a method of a rallying module according to all embodiment of the present invention.

FIG. 3 is a flow diagram illustrating a method for document information retrieval according to an embodiment of the present invention.

FIG. 4 illustrates a system for practicing one or more embodiments of the present invention.

The detailed description explains the preferred embodiments of the invention, together with advantages and features, by way of example with reference to the drawings.

### DETAILED DESCRIPTION OF SPECIFIC EMBODIMENTS

Embodiments of the present invention provide a method and system for knowledge-based ranking of retrieved business documents among enterprises, their partners and customers in a standalone or Web-based application. Knowledge is based on the profiles and preferences of an individual user, explicit metadata and dynamically extracted implicit metadata from business document properties, dynamically built user and document knowledge, and dynamically constructed specific user-document relationship parameters based on relationship rules inputted statically or dynamically altered by a user of an administrator, and static and dynamic ranking rules either build from the retrieved user's information or the user's input. The invention defines and builds specific user-document relationship parameters between an individual user and each retrieved document. User input or default values for these specific relationship parameters and their weighting factors are used in calculating ranking scores of retrieved documents.

Examples of user—document relationship parameters employed by preferred embodiments of the present invention include, but are not limited to the following:
User parameters—user name, position, department, field of interest, and user preferences such as information on any particular companies or partners, certain business or technical papers.
Document parameters—document name, title, type, value, status, creation, last access, updated or action dates, and metadata from document properties.
Dynamically built user and document knowledge—user's parent or sister departments, colleagues, partners or customers, documents containing user's department name or number, user's partners or customers' name, and contract numbers created by the user.
Static or dynamically built ranking rules—document from user's department should rank higher than other departments; document from a user's partner should rank higher than documents from user's clients, etc.
Static or dynamically built relationship rules—relationships between the user's department and document's originating department, relationships between a user's dealing parties and parties involved in the document, etc.
Dynamically constructed user-document relationship parameters—last access date by a particular user, access level of a particular user to a specific document; high score for write privilege, low score for read only privilege, relationship between user's dept and document's department; high score for same department, relationship between user's dealing parties and parties involved in the document; high score for the user's preferred partner.

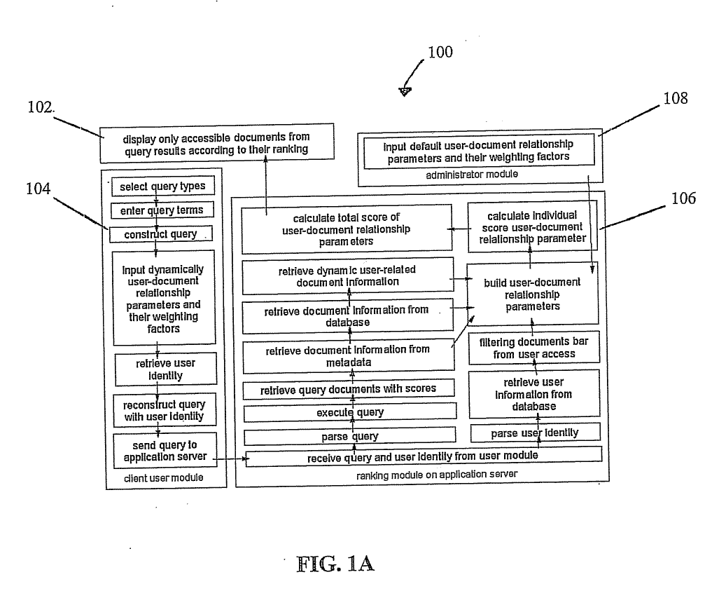

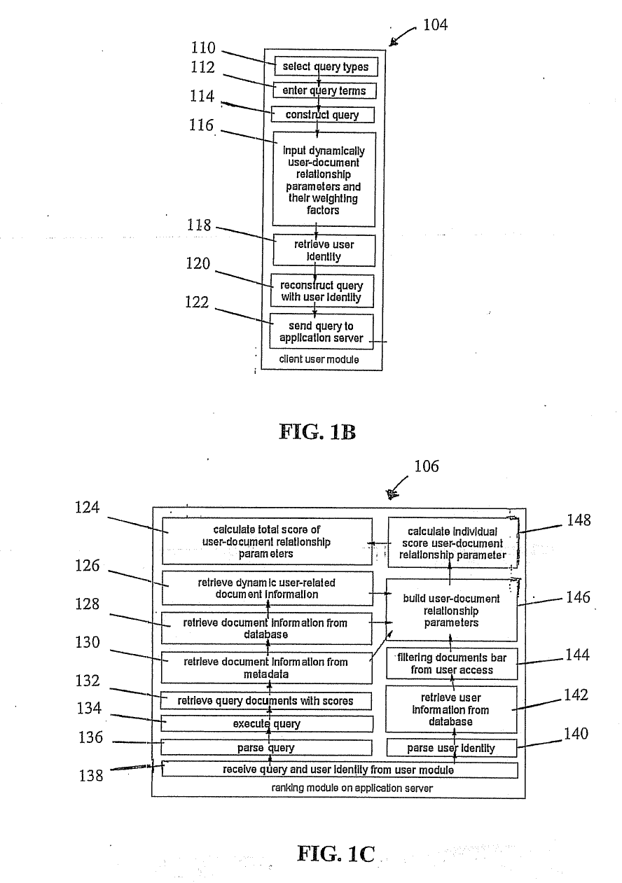

FIGS. 1A-1C illustrate a block diagram of a knowledge based ranking system 100 for a document ranking method for query results using both the explicit and the extracted implicit metadata and the knowledge of user-document relationship. The system 100 comprises an administrator module 108, which inputs and defines default user-document relationship parameters with input default values for the weighting factors of these default user-document specific relationship parameters. The administrator module 108 has a graphical user interfaces (GUIs) and means to communicate with the application server 106. A user module 104 for inputting query in terms of keywords, defining and inputting dynamically specific user-document relationship parameters, and customizing weighting factors (116) of these specific user-document relationship parameters in calculating ranking scores. Any type of document parser can be used to parse or convert the document in a particular format into the plain text format, such as a PDF parser is used to convert a document in PDF format into text format, an OCR can be used to parse the document in tiff format into text format. In addition, any generic search engine can then be used to search and extract the implicit metadata from the document in text format. After the user-document relationship parameters have been constructed, any generic ranking module can be used to calculate the score of the document.

The user module 104 has GUIs that provide a means for inputting the query and to communicate with the application server 106 for the user to customize and store user personal and business related information related to the document on the client side over a network interface such as the Internet. Users are required to input their personal and business related information related to documents at least once. However, the user can update this information as often as they want to. Within the client user module 104, the user first selects the query type 110 such as terms, key words, content search, quotation search or semantic search. Second, the user enters the query terms 112. Third, the system constructs the query 114 based on the user's query type and terms. Fourth, the system retrieves the user's information 118 such as the user reference number from the client cookie. Fifth, the system reconstructs the query 120 with user information and sends the query 122 to the application server 106. Other query parameters can also be entered by the user.

The search module 138 within the application server 106 first receives the query with user information from the user module. Second, it parses 136 and executes the query 134. Third, it retrieves query documents with relevant scores 132 from any generic search engines (not shown). Fourth, the system retrieves explicit metadata from document properties 130. Fifth, it also retrieves implicit metadata from any generic parser and extraction tools, such as a PDF parser and extraction tool to parse and extract implicit metadata. Sixth, the system 100 retrieves the document information form the system document database 128, such as the owner, department, status and access control of the document. Seventh, the system parses the user information sent from the user module 140. Eighth, the system retrieves user information 142 such as which department the user belongs to, the access level of the user. Ninth, the system builds the knowledge of the relations between the document and the user 146, such as comparing their departments, the relationship of the document owner and the user, the user's access level matched with which document access level 144. Tenth, the system 100 filtering all those documents that the user can see or access to according to the knowledge obtained from the user-document relationship. A partial score can be calculated 148 according to access control levels.

The numeric expression of access level of the user to the document is as follows:
aᵤ is the access level of the user to the document
a_{d} is the highest access level to the document
aₙ is the number of access levels of the document
wₐ is the access level weighting parameter
   while assuming the closer the access level of the user to the highest access level of the documents the higher the access score, then the partial score based on the user's access level on the document score(a) is given by equation (1) as follows,

score(a)=wₐ×(1−(a_{d}−aᵤ)/aₙ) equation (1)

If the user's access level does not belong to any of the document access levels, score(a)=0.

Eleventh, the system 100 calculates the partial score 148 based on the relationship between the departments the user belongs to and the document as follows:
dᵤ is the user's department level
d_{d} is the document's department level (The parent's department level is higher than the child's department on the same department chain.)
g_{d} is the department chain number of the document
gᵤ is the department chain number of the user
dᵤ is the number of department levels
gₙ is the number of department chain number
w_{d} is the department level weighting parameter
   then the partial score based on the relationship of the user and document department levels score(d) is given by equation (2) as follows,

score(d)=w_{d}×(1−(d_{d}−dᵤ)/dₙ×(g_{d}−gᵤ)/gₙ) equation (2)

Twelfth, the system 100 calculates the partial score 148 based on the user's ownership level of the document as follows:
eᵤ is the ownership level of the user for the document
eₙ is number of document ownership levels (assuming the owner has the highest ownership number, modifier has the second highest number and so on, and no access has a ownership number of zero)
wₑ is the ownership level weighting parameter
   then the partial score based on the user ownership level score(e) is given by equation (3) as follows,

score(e)=wₑ×(eᵤ/eₙ) equation (3)

Thirteenth, the system 100 calculates the partial score based on the document's status level as follows:
s_{d} is the status level of the document
sₙ is the number of document status levels (assuming the active status has the highest status number, pending status has the second highest number and so on, with an expired status of zero)
wₛ is the status level weighting parameter
   then the partial score based on the document status level score(s) is given by equation (4) as follows,

score(s)=wₛ×(s_{d}/sₙ) equation (4)

Finally, the final relevant score for ranking retrieved documents is given by total score 124 in equation (5) as follows,

total score=score(a)+score(d)+score(e)+score(s) equation (5)

Similarly, a partial score contributed from other relationships between user and document can be calculated in the same way as either equations (1) or (2). A partial score from other explicit and implicit user parameters can be accounted for in the same way as equation (3). A partial score based on explicit and implicit document parameters can be derived from similar equation to equation (4).

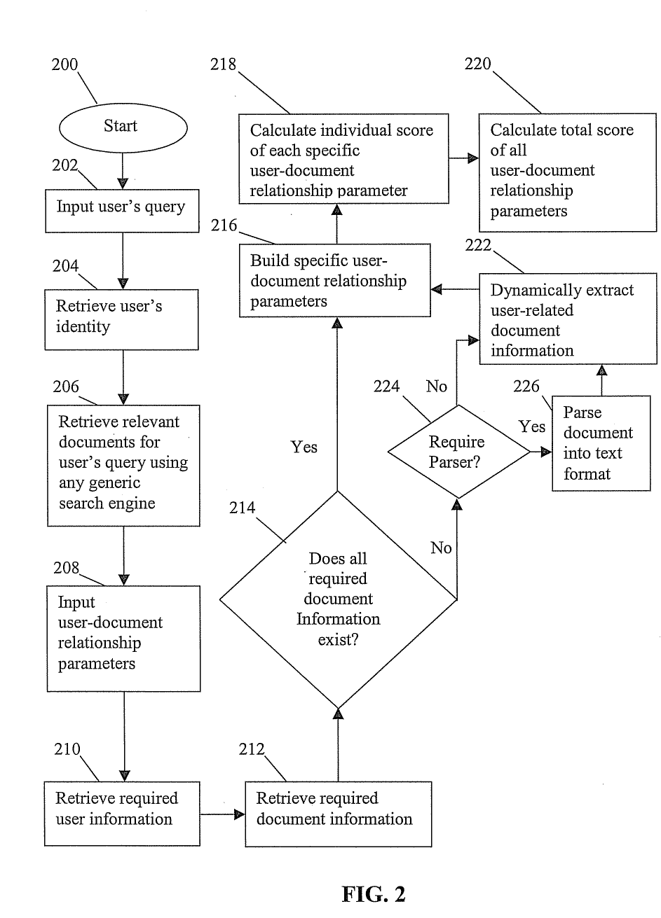

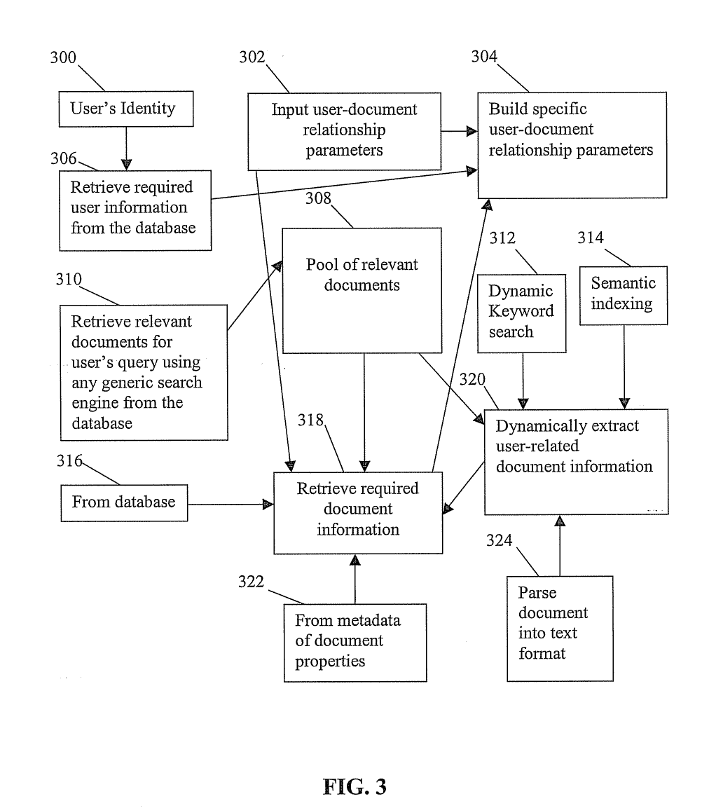

FIG. 2 is a flow diagram illustrating a possible algorithm for the ranking module 106. The algorithm starts at 200 with the input of a query 202 from the user module 104, where the query can be any dynamically defined user-document relationship parameters, their weighting factors and user identity. The user identity/information 204 is then retrieved from the user database in the application. Relevant documents are retrieved 206 using the inputted user query information 202 and any generic search engine. Inputted user-document relationship parameters 208 and retrieved required user information 210 are used to retrieve required document information 212 from extrinsic metadata within the document properties, and the document database in the application. The user-document relationship parameters can be retrieved from the user's previously stored parameters from the user's system if no updated information is entered. The algorithm then determines if all the required document information exists 214. If the information does exist, specific user-document relationship parameters 216 are built. The individual score for each specific user-document relationship parameter is calculated 218, and once all the individual scores are determined, the total score of all user document relationship parameters 220 is determined. If all the required document information does not exist 214, the user-related document information is dynamically extracted 222. If parsers are required 224, the document is parsed into a text format 226 to enable specific user-document relationship parameters to be built 216 and used in the algorithm calculations (218, 220).

The algorithm of the Ranking Module relies on building specific user-document relationship parameters 216 based on user information 210, document information 212, and default or user dynamically defined user-document parameters (208, 222). The equation to calculate an individual score 218 of each specific user-document relationship parameter is as follows:

p(i)=1.0−{[u(i)−d(i)]/n(i)} and normalized to 1;

where u(i) and d(i) are the relative rank of a particular parameter i, such as the department rank for the user and document respectively. n(i) is the highest possible rank. For an example, the user department rank is 80 while the document department rank is 60. Then their difference is 20 and the normalized score p(i) is 0.8.

The ranking score 220 is calculated by adding up scores of all user-document relationship parameters with their weighting factors using:

total score=sum i[w(i)×p(i)]/sum i[w(i)] and normalized to 1;

where w(i) is the weighting factor for parameter i. The stun i is the summation of all the scores over i.

FIG. 3 is a flow diagram illustrating a possible method for document information retrieval. The user's identity 300 is supplied to a database that is used for required user information 306. The required user information 306 is used with available currently inputted or previously inputted and stored user-document relationship parameters 302 and retrieved required document information 318 to build specific user-document relationship parameters 304. The retrieved required document information is derived from a database(s) 316, metadata of document properties 322, inputted user-document relationship parameters 302, dynamically built or constructed user-related document information 320, and a pool of relevant documents 308 that is based on user queries inputted to any generic search engine 310. The dynamically extracted user-related document information 320 can also be determined by dynamic keyword search 312, semantic indexing 314 using Latent Semantic indexing method as part of the score equation. The document in other formats rather than text format may require a parser to parse and convert it into a text format 324.

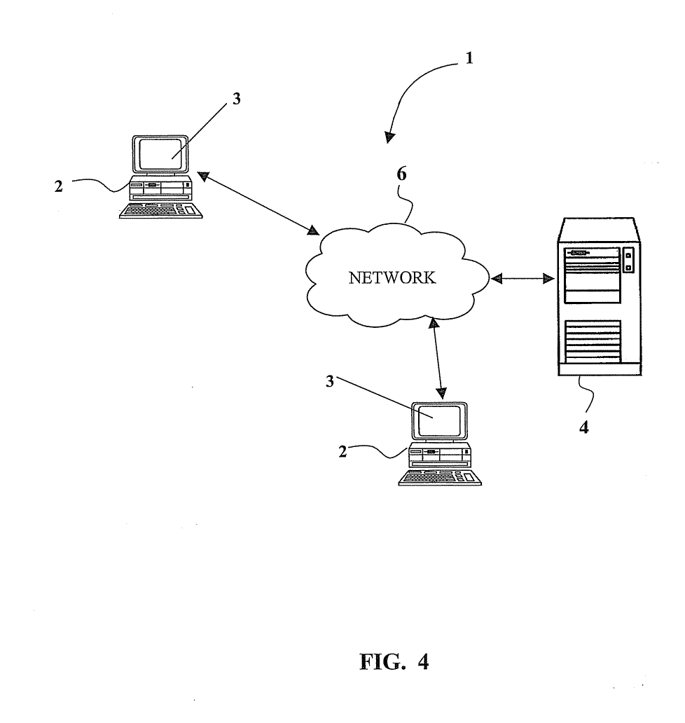

FIG. 4 is a block diagram of an exemplary system for implementing the document retrieval and ranking program of the present invention and graphically illustrates how those blocks interact in operation. The system includes one or more computing/communication devices 2 coupled to a server system 4 via a network 6. Each computing/communication device 2 may be implemented using a general-purpose computer executing a computer program for carrying out the processes described herein. The computing/communication devices 2 may also be, but are not limited to, portable computing devices, wireless devices, personal digital assistants (PDA), cellular devices, etc. The computer program may be resident on a storage medium local to the computing/communication devices 2, or maybe stored on the server system 4. The server system 4 may belong to a public service provider, or to an individual business entity or private party. The network 6 may be any type of known network including a local area network (LAN), wide area network (WAN), global network (e.g., Internet), intranet, wireless or cellular network, etc. The computing/communication devices 2 may be coupled to the server system 4 through multiple networks (e.g., intranet and Internet) so that not all computing/communication devices 2 are coupled to the server system 4 via the same network. In a preferred embodiment, the network 6 is a LAN and each computing/communication device 2 executes a user interface application (e.g., web browser) to contact the server system 4 through the network 6. Alternatively, a computing/communication device 2 may be implemented using a device programmed primarily for accessing network 6 such as a remote client. A display means 3 is provided for the user to interact with document retrieval and ranking program.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for managing document retrieval and ranking from a system, wherein the method comprises:
determining explicit metadata of a retrieved document;
extracting intrinsic metadata from inside content of the retrieved document;
determining stored information related to the retrieved document from a document system database;
obtaining information related to the retrieved document from a series of search engines;
wherein the explicit metadata, intrinsic metadata, stored information, and search engine information comprise document information;
constructing static or dynamic user-document relationship rules based on input from a user or an administrator;
establishing a knowledge of a user-document relationship by relating document information to the user's information on the document system database;
generating user-document relationships based on the knowledge of a user-document relationship and the static or dynamic user-document relationship rules;
constructing static or dynamic ranking rules based on input from the user or the administrator;
calculating a relevance or ranking score for each of the retrieved documents based on the explicit metadata, intrinsic metadata, and knowledge of user-document relationship, and the static or dynamic ranking rules;
entering a query by a user into the system with a client user module;
constructing a system query by the system based on said entering;
retrieving information about the user by the system;
reconstructing the system query with the user information by the system;
sending the reconstructed system query from the client user module to an application server by the system;
retrieving a document in response to the reconstructed system query by the application server; and
ranking the retrieved document by the application server.

2. The method of claim 1, wherein the entering of the user query comprises the entering of query types and query terms;
wherein the entering of query types comprises the entering of terms, key words, content search, and quotation search; and
wherein the entering of query terms comprises the entering of details about the query types.

3. The method of claim 1, wherein the method further comprises:
receiving the user query with the user information from the client user module;
retrieving documents with corresponding relevance scores based on the user query with a search module within the application server;
retrieving the explicit metadata by the system from the retrieved documents and their corresponding properties; and
retrieving the implicit metadata by the system from the retrieved document;
retrieving the document information by the system related to the retrieved document from the document system database; and
parsing the user information by the system for comparison to the document information; and
wherein the comparison forms the knowledge of the user-document relationship; and
wherein the knowledge of the user-document relationship is used in numerical analysis to derive the relevance and ranking score.

4. The method of claim 1, wherein the document information comprises: document name; key words; titles; creation date; last update; viewed dates; ownership; department; status; security settings and access control of the retrieved document.

5. The method of claim 1, wherein the user information comprises both personnel and business related information; and
wherein the user personnel information comprises: profile; user interests; user preferences; and user selection histories; and
wherein the user business information comprises: department affiliation; user organization and their hierarchies; user organizational rank; user document access level; user's customers, partners, and suppliers; user's colleagues and managers, user's work and business related information.

6. The method of claim 5 wherein the user business information related to the retrieved document is automatically and dynamically generated from a database on said application server side.

7. The method of claim 1, wherein the method is employed in a networked based system.

8. The method of claim 1, wherein the method is employed a in a standalone system.

9. The method of claim 1 wherein the client user module has graphical user interfaces (GUIs) and provides for communication with the server application for the user to customize and store user information related to a document on a client side of the system.

10. The method of claim 1 wherein user business information related to said document can also be automatically and dynamically generated from a database on the application server side.

11. The method of claim 1 wherein an administrator module has GUIs and provides for communication with the server application for an administrator to define and input default user-document relationship parameters and their weighting factors in calculating a total ranking score.

12. The method of claim 1 wherein the client user module has GUIs and provides for communication with the server application for the user to redefine, customize and input default user-document relationship parameters and their weighting factors in calculating a total ranking score.

13. The method of claim 1 wherein the client user module has GUIs and provides for communication with the server application for the user to dynamically modify the user-document relationship parameters and their weighting factors in calculating a total ranking score.

14. The method of claim 1 wherein a ranking module builds and calculates the total ranking scores on a set of relevant documents from search based on knowledge derived from the user-document relationship parameters and their weighting factors.

15. The method of claim 1 wherein a ranking module builds and calculates the total refined ranking scores on a returned set of relevant documents from a search based on knowledge derived from the user-document relationship parameters and their weighting factors.

16. An article comprising one or more machine-readable storage media containing instructions that when executed enable a processor to access a document retrieval and ranking program in a system that comprises computer servers, mainframe computers, desktop computers, and mobile computing devices; and
wherein the document retrieval and ranking program facilitates document searches; and
wherein the document retrieval and ranking program provides for managing document retrieval and ranking from the system by utilizing not just explicit metadata of a retrieved document, but also extracted intrinsic metadata inside content of the retrieved document, static and dynamic ranking rules constructed from a user's information or inputs from the user or an administrator, and knowledge and rules dynamically built on a user and the retrieved document based on the extracted data, and forms a dynamically constructed user-document relationship based on knowledge and rules on the user and the retrieved document by relating document implicit metadata to a user's information on a document system database, as important parameters in calculating relevance or ranking score for the retrieved documents.

17. The article of claim 16, wherein the article comprises:
an algorithm to filter, build and calculate total ranking scores on a returned set of relevant documents from a search based on knowledge derived from user-document relationship parameters and their weighting factors.

18. The article of claim 16, wherein the article comprises:
an algorithm to filter, build and calculate total ranking scores on a set of relevant documents based on knowledge derived from user-document relationship parameters and their weighting factors.

19. A system for managing document retrieval and ranking by utilizing not just explicit metadata of a retrieved document, but also extracted intrinsic metadata inside content of the retrieved document, and knowledge and ranking rules dynamically built on a user and the retrieved document based on the extracted data, and forms a dynamically constructed user-document relationship based on the static relationship rules retrieved from the system or dynamic relationship rules inputted by the administrator, and the knowledge on the user and the retrieved document by relating document implicit metadata to a user's information on the systems or databases of the user, retrieved documents and search engines, as important parameters in calculating relevance or ranking score for the retrieved documents, wherein the system comprises computing devices and at least one network; and
wherein the computing devices implement the document database; and
wherein the computing devices further comprise:
computer servers;
mainframe computers;
desktop computers; and
mobile computing devices; and
wherein the computing devices execute electronic software that manages the document retrieval and ranking; and
wherein the electronic software is resident on a storage medium; and
wherein the computing devices have the ability to be coupled to the network; and
wherein the network further comprises:
a local area network (LAN);
a wide area network (WAN);
a global network;
an Internet;
an intranet;
wireless networks; and
cellular networks.

20. The system of claim 19, wherein the computing devices further comprises:
a client user module;
a generic search engine;
a generic document parser;
a generic data extraction engine;
a dynamically derived user-document knowledge and rules built engine;
a dynamically derived user-document relationship construction engine;
a ranking module;
an application server; and
an administrator module.
